(19) United States
(12) Patent Application Publication
(10) Pub. No.: US 2008/0260189 A1
(43) Pub. Date: Oct. 23, 2008

(54) Hearing Aid Comprising Sound Tracking Means

(75) Inventor: Daniel Willem Elisabeth Schobben, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/092,278

(22) PCT Filed: Oct. 26, 2006
(86) PCT No.: PCT/IB2006/053936

§ 371 Date: May 1, 2008

(30) Foreign Application Priority Data
Nov. 1, 2005 (EP) 05110243.2

(51) Int. Cl. H04R 25/00

(52) U.S. Cl. 381/313

(57) ABSTRACT

Sound reproduction system, for example a hearing aid system, comprising:—a direction dependent sound detection system (1), comprising a number of sound detectors (2);—at least one sound generator (10) to reproduce sound, or part thereof, detected by the sound detection system (1); and—a sensitivity direction modifier (20), configured to modify a main sensitivity direction of the sound detection system (1) between at least a first and a second sensitivity direction. The invention also provides a method to reproduce sound, for example using a sound reproduction system, as well as a portable hearing aid system.

The invention relates to a sound reproduction system, for example a hearing aid system. The invention also relates to a sound reproduction method.

Such a system and method are known, for example, from international patent application WO 00/52959. The known system employs a commonly known broadside or end fire array of microphones. Microphone signals are added, to generate an output signal for a hearing aid speaker or the like. The system can be implemented in a number of devices for use by hearing impaired individuals. For example, the array system may be mounted as part of the sidepiece or arm of a pair of spectacles. In that case, during use, a user needs to face the direction of the person with whom communication is desired.

The present invention aims to improve the sound reproduction system. Particularly, the present invention aims to provide a more user-friendly system. According to an aspect of the invention there is provided a sound reproduction system, for example a hearing aid system, comprising:
a direction dependent sound detection system, comprising a number of sound detectors;
at least one sound generator to reproduce sound, or part thereof, detected by the sound detection system; and
a sensitivity direction modifier, configured to modify a main sensitivity direction of the sound detection system between at least a first and a second sensitivity direction.

In this way, the main sensitivity direction can be altered, so that a user-friendly system can be provided.

For example, in an embodiment, a user of the system can carry a sound detection part, such as a number of microphones, of the sound detection system. In that case, during use, a main sensitivity direction of the system can first be directed to a first sound source, the sound of which is to be reproduced, where after the main sensitivity direction can be directed to an other sound source to reproduce respective sound, without the user having to reposition the sound detection part he carries. Alternatively, for example, in an embodiment, a main sensitivity direction (or respective directivity pattern) can be kept focused on a sound source that moves with respect to the user carrying a mentioned sound detection part. Similarly, a main sensitivity direction (or respective directivity pattern) can be kept focused on a sound source, in case the user carrying a mentioned sound detection part moves with respect of the sound source. In such embodiments, for example, the user does not need to keep the sound detection part physically directed towards a sound source to be listened to, particularly since the sensitivity direction modifier can steer the main sensitivity direction of the detection system towards to the sound source. Also, as an example, the system can be configured to modify the main sensitivity direction of the sound detection automatically and/or by user control. Besides, suitable tracking means can be provided to track a sound source to be detected, to track movement of a sound detection part of the system (such as a number of sound detectors) and/or to track movement of a user part carrying such sound detection part.

An underlying notion of the present invention is, that a disadvantage of a known system is, that a user needs to face the direction of the person with whom communication is desired. The features of claim 1 of the present invention can solve this problem in a simple manner, as will be explained in more detail concerning the embodiments below.

An other aspect of the invention provides a method to reproduce sound, for example using a system according to the invention, the method comprising:
providing a direction dependent sound detection system, which at least detects sound it receives from a main sensitivity direction;
providing at least one sound generator to reproduce sound, or part thereof, detected by the sound detection system; and
modifying the main sensitivity direction of the sound detection system, particularly to compensate for movement of at least part of the sound detection system with respect to a remote sound source and/or vice-versa.

This method can provide the above-mentioned advantages. For example, the method can be used in a method of increasing speech intelligibility, or for a different purpose. Particularly, the method can simply modify one or more main sensitivity directions of the direction dependent sound detection system, for example to track remote sound sources and/or to compensate for movements of a carrier of at least part of the system.

Besides, an aspect of the invention provides a portable hearing aid system. According to the invention, the portable hearing aid system is at least configured to carry out the above-mentioned method according to the invention. For example, such a portable hearing aid system can be configured as a sound reproduction system according to the invention.

An other aspect of the invention provides a portable hearing aid device, including a pair of spectacles, for example a device of a system according to claim 23, the pair of spectacles being provided with a manually operable or touch sensitive user interface module.

Further advantageous embodiments of the invention are described in the dependent claims.

The invention will now be described in more detail on the basis of exemplary embodiments shown in the accompanying schematic drawing. Therein shows:

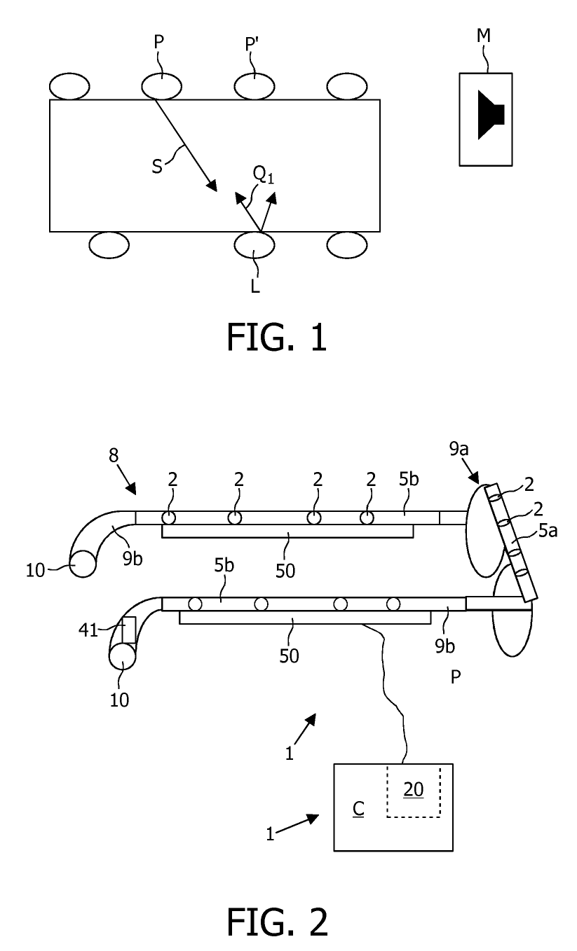

FIG. 1 a top view of a listening environment;

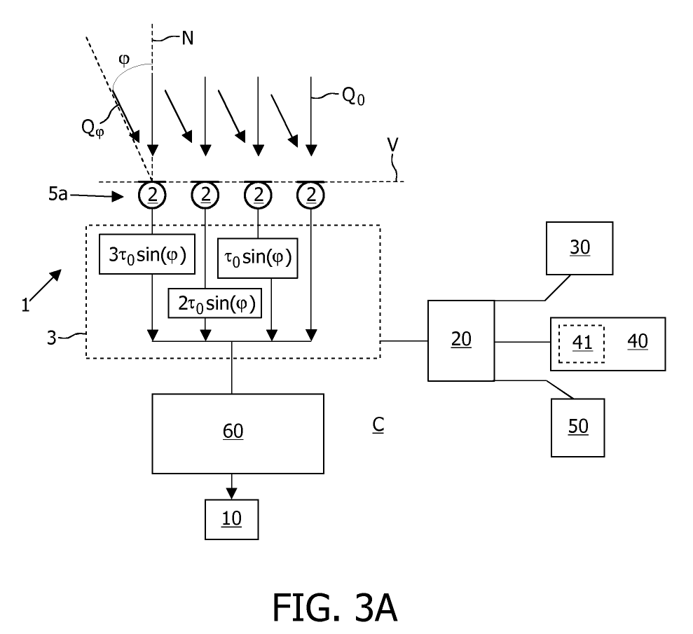

FIG. 2 an embodiment of the invention;

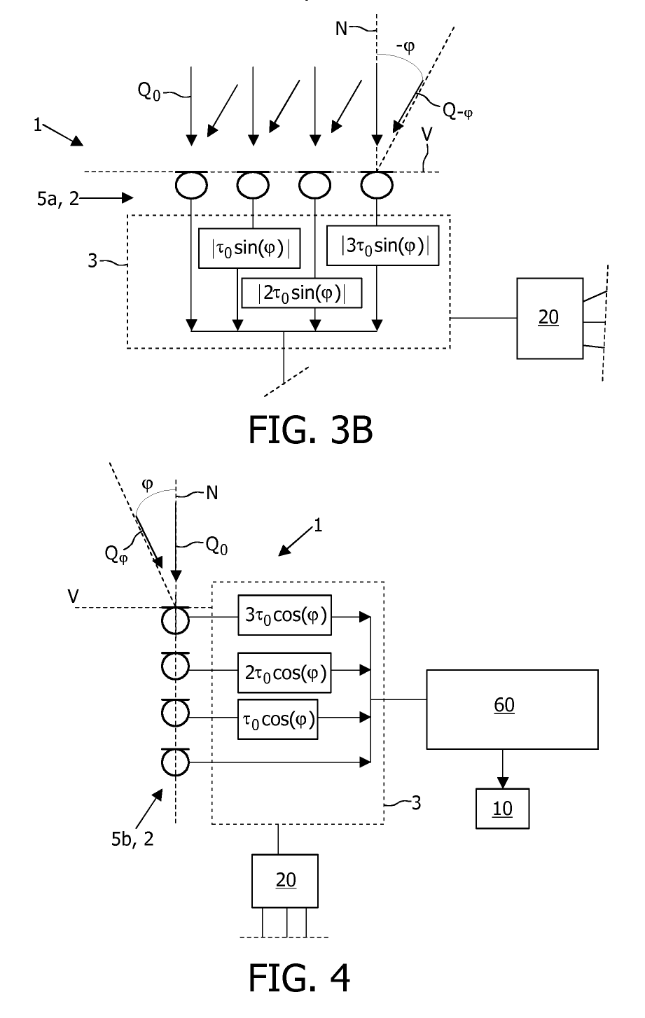

FIGS. 3A, 3B diagrams of part of the embodiment shown in FIG. 2; and

FIG. 4 a similar diagram as FIG. 3A of an alternative embodiment.

In the present application, corresponding or similar features are denoted by corresponding or similar reference signs.

FIG. 1 schematically depicts a top view of a listening environment, for example an environment wherein a number of people meet and talk with each other, such as in a meeting or social gathering. For example one person L listens to sound S produced by an other person P.

FIG. 2 schematically depicts an embodiment of a portable sound reproduction system, for example a hearing aid system. The system can comprise a sound detection system 1 and at least one sound generator 10 to reproduce sound, or part thereof, detected by the sound detection system 1. Such a sound reproduction system can be used by a person L as an hearing aid system, for example in case the person L has a hearing defect and/or in case the hearing of one sound source (such as a voice of an other person P) is difficult due to certain factors such as background noise, sound emanating from sound sources M which the person L does not primarily desires to hear, and/or due to other factors.

The sound reproduction system can be configured and constructed in various ways. As an example, the system can be configured to provide monaural use or binaural use. Preferably, the sound reproduction system is substantially portable, for example relatively compact and lightweight, to be carried by a single user L. For example, a sound detection part 2 of the system can be configured to be carried by the user L. The same holds for the sound generator 10 of the system.

In the present, non-limitative embodiment, the sound reproduction system includes a plurality of sound detectors 2, two sound generators 10 and a control C. As an example, the sound generator 10 can be provided to feed sound to two respective ears of the user L. The sound generators can include suitable sound transducers, loudspeakers or other sound generators.

The sound detectors 2 can comprise suitable sound transducers, microphones or other sound detectors. In a further embodiment, one or more arrays 5 of sound detectors 2 is/are provided. Using such array or arrays, a direction sensitive sound detection can be provided, as known from the art.

As an example, shown in FIG. 2, the system can be provided with a pair of spectacles 8, wherein a front side 9a and/or one or more arms 9b of the pair of spectacles 8 is provided with microphones 2, or one or more of microphone arrays 5. As an example, a first microphone array 5a can be mounted at a front side of the unit, to be worn substantially in front of a user L. Also, one or more first microphone arrays 5b can be configured to be carried alongside a user L, for example in case such an array 5b is mounted on an arm 9b of the pair of spectacles 8. Also, such a pair of spectacles 8 may be provided with one or more of the sound generators 10 (see FIG. 2). Alternatively, the one or more sound generators 10 can be provided separately. Portable units other than a pair of spectacles, which can be provided with a system or part of a system according to the invention, can include headbands, neck loops, wristbands, pens, personal digital assistants (PDAs), clothing, mobile telephones and/or other portable units.

The sound detectors 2 and sound generators 10 of the system can be coupled to the control C of the system in various ways, for example via suitable wireless and/or wired communication lines. Also, the control C can be spaced apart from sound detectors 2 and/or sound generators 10, or be located near sound detectors 2 and/or sound generators 10, or be joined therewith. Besides, such a control C, or part thereof, can be partly of fully integrated in a system part, such as the pair of spectacles 8 or on other part that can be carried by the user L, which part 8 is provided with the sound detectors 2 and/or sound generators 10. Besides, the system can include a power supply (not shown), such as a rechargeable battery, to provide power to various system parts.

The control C can be arranged in several ways. For example, the control C can be configured to receive sound detection signals from the sound detectors 2, to process and/or amplify the sound detection signals and to feed sound output signals to the sound generators 10, the sound output signals being dependent of the sound detection signals. The control C can include, for example, a sound signal processor and/or amplifier 60, see FIG. 3A. As an example, the sound output signals can include amplified sound detection signals, or amplified parts of sound detection signals. The control C can be provided with suitable electronics, microelectronics, hardware, software, one or more signal processors, computer means and/or other means suitable to control the sound reproduction.

In a further aspect, the sound detection system is a direction dependent sound detection system 1, comprising a number of sound detectors 2 which can provide the system with a main sensitivity direction. For example, the main sensitivity direction can be the direction, viewed or measured from the number of sound detectors 2, for which main sensitivity direction the system is configured to be more sensitive to detect sound than for other directions during use. In the present embodiment, the main sensitivity direction of the system 1, viewed from the number of sound detectors 2, can be varied during use, as will be explained below.

A direction dependent sound detection system as such, for example in combination with a pair of spectacles having a broadside array of sound detectors mounted on its front, or an end-fire array mounted on a side piece of a pair of spectacles, is known from the art. However, in the known system, the user L of the pair of spectacles has to face the direction Q1 of the person P with whom communication is desired (see FIG. 1).

According to an embodiment, advantageously, the system is provided with a sensitivity direction modifier 20, configured to modify the main sensitivity direction of the sound detection system 1 between at least a first and a second sensitivity direction. For example, such a direction modifier 20 can be part of the control C of the system 1.

FIGS. 3A, 3B show a more detailed example of a system according to an embodiment of the invention. In the embodiment of FIG. 3A, 3B, only a single array 5a of microphones 2 is provided. The array can be a so-called broad side array. Alternatively, the system can include more than one array of microphones, such as is shown in FIG. 2.

In FIG. 3A, the microphone array 5a extends substantially along or parallel to a virtual detection plane V. The system is provided with a summing device 3, configured to sum or join microphone signals produced by the respective microphones 2. Such a summing device can be configured in various ways, as will be clear to the skilled person. For example, the summing device can be configured to sum or join microphone signals digitally and/or by analogue means.

The sensitivity direction modifier 20 is configured to control the summing device 3 to modify the mentioned sensitivity direction. In the present embodiment, the sensitivity direction modifier 20 is configured to adjust the summing device 3 between at least a first summing mode and a second summing mode, to modify the mentioned sensitivity direction between respective sensitivity directions. In the present embodiment, the summing device 3 and sensitivity direction modifier 20 are depicted as separate units, however, the summing device 3 and sensitivity direction modifier 20 can also be integrated with each other, as will be clear to the skilled person.

Particularly, the sensitivity direction modifier 20 is configured to adjust the summing device 3 such, that the summing device adds microphone signals relating to sound received from a desired main sensitivity direction, to each other substantially in phase. The summing device 3 can simply be configured to adjust time delays of the microphone signals with respect to each other, such that microphone signals resulting from detection of a sound coming from a certain detection direction can be added in phase. Herein, the sensitivity direction modifier 20 can be configured to control the adjusting of the time delays to modify the sensitivity direction. In a further embodiment, the summing device 3 is configured to join microphone signals of neighboring microphones 2 with a time delay τ=τ_{n.} cos(φ+k), wherein τₙ is a respective constant, in seconds, k is a constant in rad, and φ is the main sensitivity direction angle with respect to the normal N of the detection plane V of the respective microphone array 5, in rad, as is shown in FIG. 3A. The sensitivity direction angle φ is adjustable by the sensitivity direction modifier 20, for example electronically.

In general, the mentioned constants τₙ will be dependent of distances between the respective neighboring microphones 2. For example, in case the microphones are positioned in line with each other, at mutually the same distance, such as in FIG. 3A, the constant τₙ may be the same for each pair of neighboring microphones 2. Thus, in FIG. 3A τₙ=τ₀ for each pair. In the embodiment of FIG. 3A, k=π/2. Thus, the time delay to be applied is τ=τ_{0.} sin(φ). Alternatively. constants τₙ may differ, for example to allow a certain focusing of the microphone array 5.

Also, to provide in-phase summing of sound signals relating to a detected sound, the sound signal of the microphone 2 that detects the sound first will be provided with a cumulatively largest time delay, τ=3τ_{0.} sin(φ), or τ=|3τ_{0.} sin(φ)|, in the present embodiment. The sound signal of the microphone 2 that detects the sound last is preferably be provided with no time delay (τ=0) in the present embodiment.

For example, to provide a main sensitivity for sound coming straight towards the detection plane V, parallel to a normal N of that plane V, in a first direction Q₀, the summing device can be in a first summing mode wherein φ=0, so that all the time delays τ will be 0. If a user L desires to change the main detection angle of the system without having to change the position/orientation of the microphone array, the user simply adjusts the summing device 3, to provide appropriate time delays to alter the sensitivity direction. As is shown in FIG. 3A, if sound from a second direction Q_{φ} is to be detected, the second and first direction enclosing an angle φ, the summing device can be adjusted to a second summing mode wherein time delays τ=τ_{0.} sin(φ) are applied to a number of the microphone signals of the array 5, before adding the signals, such that the signals are joined in phase.

FIG. 3B shows, alternatively, how the system can be controlled to listen to sounds coming from a third direction Q−_{φ} with respect to the detection plane V, the third direction Q−_{φ} enclosing an angle −φ with the first direction Q₀. In this case, the sound will reach the microphones 2 in a reverse order with respect to the FIG. 3A embodiment. In this case, the summing device 3 is adjusted, to provide appropriate time delays to alter the sensitivity direction, wherein time delays τ=τ_{0.} sin(φ) are applied to a number of microphone signals as well, before adding the signals. Again, to provide in-phase summing of sound signals relating to a detected sound, the sound signal of the microphone 2 that detects the sound first will be provided with the cumulatively largest time delay. Besides, in FIG. 3B, the delays are depicted between straight brackets |, to indicate that virtual negative time delays values can be turned to positive delay values. For example, the system can be configured to detect whether the FIG. 3A or FIG. 3B embodiment should be carried out, depending on the desired sensitivity direction with respect to the virtual detection plane V.

In the alternative embodiment of FIG. 4, a system is shown, which differs from the embodiment of FIGS. 3A, 3B, in that an end-fire array 5b of microphones 2 is provided. This array 5b extends substantially perpendicular to a virtual detection plane V, and therefore parallel to the normal N of that plane V. Similar to the FIG. 2 embodiment, in FIG. 3, time delays can be added to sound detection signals to add the signals in phase, to select a certain listening direction. In this case, time signals of the microphones are cumulatively delayed by τ=τ_{n.} cos(φ), wherein signals from the first microphone (closest to the detection plane V) are provided with the largest time delay τ=3τ_{0.} cos(φ), whereas signals from the last microphone (being farthest away from the detection plane V) are preferably not delayed. In the present embodiment, maximum time delays are applied in case φ=0, whereas the time delays are 0 if φ=90°.

In a further embodiment, the sound reproduction system comprises a sound source-tracking device 30 to track the position of a remote sound source P, and/or to track a direction of sound produced by the sound source. As an example, the sound source-tracking device 30 can be part of the mentioned sensitivity direction modifier 20, and/or be operatively coupled thereto. For example, the sensitivity direction modifier 20 and sound source tracking device 30 can be configured to cooperate, to adjust or focus the sensitivity direction φ of the sound detection system to a location of the sound source. The tracking device 30 can be configured in various ways. As an example, the tracking can be provided by electronically tracking, video and/or audio based tracking, by a sound source sensor, by source positioning means, by a suitable sound source localization (SSL) technique. For example, the tracking sensor can include a stationary microphone array to provide sound source localization.

Further, advantageously, a sound detector tracker 40 can be provided, to track the position of at least the sound detection part 2, i.e. the microphones 2 in the present embodiment, of the system. The sound detector-tracking device 40 can also be configured in various ways. As an example, sound detector tracking can be provided by electronically tracking, video and/or audio based tracking, by a sound detector position sensor, by sound detector positioning means or in a different way. In this way, changes of the position of microphones 2 can be compensated, such that the main sensitivity direction can remain focused on a remote sound source P to be listened to by the user L. The sound detector tracker 40 can be part of the mentioned sensitivity direction modifier 20, and/or be operatively coupled thereto.

In case at least a sound detection part 2, for example the mentioned one or more sound detectors or microphone arrays, are configured to be carried by a user L, the sound detector tracking device 40 can also be configured to track the position of at least the part of the user L, which part carries the microphones 2 during use.

Moreover, in case the sound detection part 2 is configured to be carried by a head of a user L, the sound detector tracking device 40 can be configured to detect movement of the user head, for example to track rotation of the user head. For example, to this aim, the system can be provided with a suitable rotation sensor 41, configured to detect rotation of the user head. As an example, a mentioned pair of spectacles 8 can be provided with such a sensor 41. The head position sensor can include, for example, a sensor providing a sensor signal that is dependent of a position of the user head, an acceleration detector, a variable electronic component which is adjustable by head movements, and/or a different sensor.

Preferably, the sound detector tracker 40 is configured to allow a substantial instantaneous tracking of the position of the sound detection part 2. For example, in case the sound detection part 2 is configured to be carried by a head of a user L, the tracking of movement of the head of the user can be carried out in a relatively simple, precise and instantaneous manner. This can be advantageous over the application of a sound source-tracking device, particularly in case the sound source-tracking device includes a mentioned stationary microphone array.

Preferably, the sensitivity direction modifier 20 is controllable by a user to change the sensitivity direction during use. As an example, the sensitivity direction modifier 20 can be provided with, and/or operatively coupled to, a manually operable or touch sensitive user interface module or user interface 50. In an embodiment, shown in FIG. 2, one or more of such modules 50 are provided on the pair of spectacles 8, for example on the arms 9b thereof. For example, the user interface module can be configured to detect manual tapping on one or both arms of the pair of spectacles. For example, a left arm of the pair of spectacles 8 can include an interface part, to be operated to modify the sensitivity direction towards the left, and a right arm of the pair of spectacles 8 can include an interface part, to be operated to modify the sensitivity direction towards the right. Also, the user interface 50 can include one or more operable knobs, switches or other user interface means.

During use of the present embodiment, the sound detection part 2 and the sound generators 10 can be carried by a user, for example simply by wearing the pair of spectacles 8, and for example during detection of sound S by the sound detection system 1. The sound detection system 1 receives sound S, that comes from a certain main sensitivity direction. The one or more sound generators 10 can reproduce sound, or part thereof, detected by the sound detection system 1.

The main sensitivity direction of the directionally sensitive sound detection system 1 can simply be modified, for example between at least a first sensitivity direction Q₀ and a second sensitivity direction Q_{φ}, the directions Q₀ and a second sensitivity direction Q_{φ} enclosing an angle φ with each other, particularly to compensate for movement of at least part 2 of the sound detection system with respect to a remote sound source P and/or vice-versa.

In the embodiments of FIGS. 3 and 4, for example, the at least one array 5 of microphones 2 can produce respective microphone signals. The microphone signals can simply be joined utilizing certain joining parameters, wherein the joining parameters are adjusted to modify the mentioned sensitivity. In particular, the joining parameters are adjusted to add the microphone signals, which result from the sound received from the desired detection direction, in phase. Herein, time delays can be included between the microphone signals, wherein the time delays are being adjusted between a first set of time delays and a second set of time delays to modify the sensitivity direction between the first and second direction respectively. As follows from the above, and is depicted in the figures, the microphone signals of neighboring microphones 2 can be joined with a time delay τ=τ_{n.} cos(φ+k). Then, the sensitivity direction angle φ can be adjusted between at least a first sensitivity direction angle φ=0 for detection of sound from the first sensitivity direction Q₀, and the second sensitivity direction angle φ=φ for detection of sound from the second sensitivity direction Q_{φ}.

Furthermore, in an aspect, during use, a remote sound source P can be being tracked by the sound source tracker 30, wherein the sensitivity direction of the sound detection system can be adjusted to the location of the sound source, to receive sound therefrom.

Also, a position of at least a sound detection part 2 of the of the sound detection system 1 can being tracked, by the suitable tracking unit 40. The sensitivity direction of the sound detection system can then be adjusted to changes of the position of the sound detection part 2. This is advantageous, for example, when the sound detection part 2 is carried by a user L during the tracking of the position of that part 2. Besides, in the latter case, the position of at least part of the user L can be monitored to track the position of the sound detection part 2. For example, rotation of a head of the user L—wearing the pair of spectacles 8—can be detected, wherein a respective movement of the a microphone array is compensated automatically.

The main sensitivity direction of the sound detection system 1 can, for example be gradually adjusted between at least a first and a second sensitivity direction. On the other hand, the system can be configured such that the main sensitivity direction of the directionally sensitive sound detection system 1 is abruptly adjusted between at least a first and a second sensitivity direction.

Besides, in an embodiment, the main sensitivity direction of the sound detection system 1 can be adjusted to receive sound from a first sound source P first, and to receive sound from a different sound source P′ second (see FIG. 1). For example, the change of the sensitivity direction can be automatic, or user controlled via one or more control modules 50.

As an example, usually, it can be hard to know who the “desired speaker” P is, and additional information can be needed such as video input. Known hearing aid products are given a fixed directivity, such as known hearing glasses, wherein the user always needs to look directly to the person he wants to speak to at all times, which is unnatural and undesired. This can be avoided by the present invention is a simple and inexpensive manner.

For example, following from the above, a microphone array 5 can be equipped with means to compensate for rotation of the array. The array 5 can also be equipped with a suitable user interface 50 to adjust and/or lock the array 5 to a target direction. In addition, an adaptive tracking mechanism 30, 40 may be provided to keep the array 5 locked onto a target person.

In a preferred embodiment, a system according to the invention can be provided with hearing glasses 8 can be equipped with one or a couple rotation sensors 41, for example to detect rotation of the head of the user. A user interface 50 can be provided to lock a directivity pattern of the sound detection system 1 onto the person or sound source P, which the user L currently faces. This user interface 50 may comprise, for example, a suitable remote control, means to detect tapping (in a predefined pattern) of the users' hand onto the device itself, or a different user interface configuration. In an embodiment, a manual tapping or touching of a left arm of the pair of spectacles 8 can modify the sensitivity direction towards the left, and a manual tapping or touching of a right arm of the pair of spectacles 8 can modify the sensitivity direction towards the right.

Also, for example, when the user L turns his head, carrying the glasses 8, the movement of the head can be detected by the sensor(s) 51 of the pair of spectacles 8, and a respective directivity pattern of the microphones 2 can be adapted accordingly by the user, or automatically, hence allowing for free head movement while the microphone array 5 can maintain locked on the target direction.

In a yet a further embodiment, an adaptive tracking system 30 can be incorporated, which tracks the position of the target person or target sound source p. The tracking system 30 can be used to further steer the directivity pattern of the sound detection system.

In yet a further embodiment, a mentioned sound source tracking system 30 can be configured to propose one or more candidate direction in which it detected the presence of sound sources such as speakers P, P′. For example, the user L of the system can select one of the proposed sound sources P, P′ through a user interface.

The sound reproduction system can also be provided, for example, with body worn microphone arrays 5, such hearing glasses, assistive listening devices, such as a microphone array that hooks up wirelessly to a headset and other devices that are equipped with microphone arrays and may be rotated during use such as mobile phones.

Besides, in an further embodiment, a sound reproduction system including sound generators for both ears of a user (such as in FIG. 2) can be adapted in a simple manner to give the user of the system the impression, that sound comes from a certain fixed direction, for example during movement of the user with respect to the respective sound source. For example, a head rotation sensor can be provided to detect rotation of the head of the user, wherein the user head carries both the sound generators and the sound detectors of the system. In case the user first listens to a sound source located for example in front of the user, and then turns his head to the left, the gain of the right ear sound generator can simply be increased, the gain of the left ear sound generator can be decreased and/or sound of the left ear sound generator can be provided with a respective time delay, such that the user perceives the sound coming from the right. Similarly, head turns towards the right can lead to an increase of the gain of the left ear sound generator, a decrease of the gain of the right ear sound generator, and/or a respective time delay of sound produced by the right ear sound generator, such that the user perceives the sound coming from the left. The amount of gain increase, gain decrease and/or time delay can be based on the amount of head rotation, as is detected by the head rotation sensor. Again, each time the user moves his head, a sensitivity direction modifier 20 can direct a main sensitivity direction of the sound detection system towards the sound source to be listened to.

Although the illustrative embodiments of the present invention have been described in greater detail with reference to the accompanying drawings, it will be understood that the invention is not limited to those embodiments. Various changes or modifications may be effected by one skilled in the art without departing from the scope or the spirit of the invention as defined in the claims.

For example, the term ‘sound reproduction’ should be interpreted broadly, since the system and method can be configured to reproduce one or more sounds in various ways, for example to provide a substantially total reproduction of detected sound, or partial reproduction, and/or to amplify sound, distort sound, process sound, and/or in a different way. The system and method can include one or more digital and/or analogue sound reproduction methods. Besides, the direction dependent sound detection system can have only one a main sensitivity direction, for example in case the detection system comprises only one microphone array, or more main sensitivity directions, for example in case the system comprises at least two microphone arrays. Besides, for example, the system can be configured to modify a width of a sound capture region, for example next to being able to modify a respective main sensitivity direction as such. Besides, the system can be configured to modify a sensitivity direction in various directions, for example 1-dimensionally, 2-dimensionally or in a different way.

1. Sound reproduction system, comprising:
a direction dependent sound detection system sound detectors;
at least one sound generator to reproduce sound, or part thereof, detected by the sound detection system; and
a sensitivity direction modifier configured to modify a main sensitivity direction of the sound detection system between at least a first and a second sensitivity direction.

2. System according to claim 1, wherein the sound detectors of the direction dependent sound detection system are configured to be carried by a user.

3. System according to claim 1, further comprising a sound detector tracking device to track a position of at least the number of sound detectors, wherein the sensitivity direction modifier and sound detector tracking device are configured to adjust the sensitivity direction of the sound detection system depending on a change of the position of the number of sound detectors.

4. System according to claim 3, wherein the sound detectors are configured to be carried by at least part of a user, and wherein the sound detector tracking device is configured to detect movement of the respective user part.

5. System according to claim 2, wherein the sound detector-tracking device is provided with a rotation and/or acceleration sensor.

6. System according to claim 1, wherein the sensitivity direction modifier is controllable by a user to change the sensitivity direction during use.

7. System according to claim 1, further comprising a pair of spectacles provided with the sound detectors.

8. System according to claim 1, further comprising a sound source tracking device to track a position of a remote sound source and/or direction of sound produced by the sound source, wherein the sensitivity direction modifier and sound source tracking device are configured to hold the main sensitivity direction substantially focused onto the remote sound source.

9. System according to claim 1, wherein the sound detectors includes at least one array of microphones (2) and at least one summing device, the microphones being configured to produce respective microphone signals, and the summing device being configured to join the microphone signals, wherein the sensitivity direction modifier is configured to adjust the summing device between at least a first summing mode and a second summing mode.

10. System according to claim 9, wherein the sensitivity direction modifier is configured to adjust the summing device such that the summing device adds microphone signals relating to sound received from a desired main sensitivity direction substantially in phase.

11. System according to claim 9, wherein the summing device is configured to join microphone signals of two neighboring microphones with a time delay τ=τ_{n.} cos(φ+k), wherein τₙ is a respective constant in seconds, k is a constant in rad, and φ is the main sensitivity direction angle in rad.

12. System according to claim 1, wherein the sound generator is configured to be carried by a user during use of the system.

13. Method to reproduce sound comprising:
providing a direction dependent sound detection system for detecting sound received from a main sensitivity direction;
providing at least one sound generator to reproduce sound, or part thereof, detected by the sound detection system; and
modifying the main sensitivity direction of the sound detection system to compensate for movement of at least a sound detection part of the sound detection system with respect to a remote sound source to be detected.

14. Method according to claim 13, wherein the sound detection system comprises at least one array of microphones, the microphones being configured to produce respective microphone signals, wherein the microphone signals are joined utilizing certain joining parameters, wherein the joining parameters are adjusted to modify the sensitivity direction.

15. Method according to claim 14, wherein the joining parameters include time delays between the microphone signals, wherein the time delays are being adjusted to modify the sensitivity direction.

16. Method according to claim 14, wherein microphone signals of two neighboring microphones are joined with a time delay τ=τ_{n.} cos(φ+k), wherein τₙ is a respective constant in seconds, k is a constant in rad, and φ is the main sensitivity direction angle in rad.

17. Method according to claim 13, wherein a remote sound source is being tracked, wherein the sensitivity direction of the sound detection system is being focused substantially towards the sound source.

18. Method according to claim 13, wherein a position of at least a sound detection part of the of the sound detection system is being tracked, wherein the sensitivity direction of the sound detection system is adjusted to changes of the position of the sound detection part.

19. Method according to claim 13, wherein a sound detection part of the sound detection system and/or the at least one sound generator (10) is being carried by a user.

20. Method according to claim 18, wherein the position of at least part of the user is being monitored to track the position of the sound detection part.

21. Method according to claim 20, wherein at least one sound generator is provided for each ear of the user, wherein sound generated by the sound generators is being adapted during movement of at least part of the sound detection part, to give the user the impression that the sound comes from a certain fixed direction with respect to the user, wherein the sound generators and sound detection part are carried by the same part of the user.

22. Method according to claim 13, wherein the main sensitivity direction is directed to a first remote sound source, where after the main sensitivity direction is be directed to an other remote sound source without repositioning at least a sound detection part of the sound detection system.

23. (canceled)

24. (canceled)

25. (canceled)
